(19) United States
(12) Patent Application Publication
(10) Pub. No.: US 2025/0154006 A1
(43) Pub. Date: May 15, 2025

(54) MANUFACTURE OF AN ANODE MATERIAL WITH SIMILAR SOFT CARBON AND AN APPLICATION THEREOF

(71) Applicant: Glory Material Co., Ltd., New Taipei City (TW)

(72) Inventors: SHIAN-TSUNG CHOU, New Taipei City (TW); YU-SHIANG WU, New Taipei City (TW)

(21) Appl. No.: 18/508,044

(22) Filed: Nov. 13, 2023

(51) Int. Cl. C01B 32/05; H01M 10/05

(52) U.S. Cl. CPC C01B 32/05; H01M 10/05; C01P 2004/02; C01P 2004/03; C01P 2004/61; C01P 2006/40

(57) ABSTRACT

The invention is a manufacture of the anode material with similar soft carbon and an application thereof, which includes: using the isotropic coke to be heated through calcining; using the isotropic coke after calcining and heating, and then crushing the isotropic coke into particulate form, using the isotropic coke in particulate form and heating it under the heat treatment range of 2100 degrees Celsius to 2600 degrees Celsius to form the similar soft carbon; and using the similar soft carbon after mixing and sieving, the similar soft carbon is used the particle mean size 2 μm to 15 μm as the anode material.

### BACKGROUND OF THE INVENTION

### Field of the Invention

The present invention relates to the technical field of an anode material, in particular a manufacture of an anode material with similar soft carbon and application thereof.

### The Prior Arts

Battery anode materials in the prior art are used graphite, hard carbon and soft carbon as anode materials. The physical properties of the battery anode materials are determined by the layer spacing, particle size, and superposition condition of the material structure, comprising: the discharge capacity ratio effect of the discharge rate, and the charge capacity ratio effect of the charge rate. The capacity retention effect of cycling in a high temperature environment of 45 degrees Celsius.

The interlayer spacing of the soft carbon in the foregoing prior art is between 0.370 nm and 0.400 nm. The interlayer spacing for fully graphitized in the foregoing prior art is 0.3354 nm. Compared with the similar soft carbon of the present invention, the interlayer spacing of d002 is soft carbon≥similar soft carbon≥graphite. However, limited by the materials conditions of layer spacing, particle size, and the superposition, therefore soft carbon, hard carbon, and graphite in the prior art which cannot produce the foregoing excellent physical properties of the similar soft carbon material of the present invention.

### SUMMARY OF THE INVENTION

The present invention is a manufacture of an anode material with similar soft carbon and application thereof. The modified method comprises: Step 1: Using isotropic coke and heating the isotropic coke through calcination; Step 2: Using the isotropic coke heated to calcine in step 1, and then grind the isotropic coke in step 1 into particulate form; Step 3: Using the isotropic coke in the form of particles in Step 2 to be heated to the heat treatment range from 2100 degrees Celsius to 2600 degrees Celsius to form a type of said similar soft carbon; and Step 4: Using the similar soft carbon in Step 3, the similar soft carbon has a particle mean size of 2 μm to 15 μm after mixing and sieving which is configured for the anode material.

The present invention is a manufacture of an anode material with similar soft carbon, wherein the degree of graphitization (g) of the similar soft carbon,

$$( g ) = \frac{0.344 - d 002}{0.344 - 0.3354} \times 100 \% = 70 \% to 82 \% ,$$

wherein d002 is the interlayer spacing (d spacing) of the similar soft carbon, where the interlayer spacing of the similar soft carbon ranges from 0.33798 nm to 0.33695 nm.

The present invention is a manufacture of an anode material with similar soft carbon, wherein the charging rate of the similar soft carbon is 0.2 C to 10 C, the charging capacity ratio is between 100% and 88% thereof.

The present invention is a manufacture of an anode material with similar soft carbon, wherein a discharge rate of the similar soft carbon is 0.2 C to 10 C, a discharge capacity ratio is between 100% and 97% thereof.

The present invention is a manufacture of an anode material with similar soft carbon, wherein the similar soft carbon has a capacity retention rate of 99% to 90% after 200 to 600 cycles of charge and discharge in an environment of 45 degrees Celsius.

The present invention is a manufacture of an anode material with similar soft carbon, wherein the similar soft carbon has a discharge capacity ratio of 100% to 90% in an environment of 25 degrees Celsius to −10 degrees Celsius, wherein the discharge capacity ratio of the similar soft carbon is 90% to 85% in an environment of −10 degrees Celsius to −20 degrees Celsius.

The present invention is a manufacture of an anode material with similar soft carbon, wherein the similar soft carbon is applied to lithium ion batteries and sodium ion batteries.

The present invention is an application of an anode material with similar soft carbon, wherein the application of the similar soft carbon is applied to a start-stop battery, a starting battery, and a high-power hybrid electric vehicle (HEV) battery.

The invention is an application of an anode material with a similar soft carbon and a method thereof, which overcomes the shortcomings of anode materials such as Mesocarbon Microbeads (MCMB), an artificial graphite, a natural graphite. The technical method is to use isotropic coke, control the graphitization temperature in the range of 2100 degrees Celsius to 2600 degrees Celsius, after mixing and sieving the particle mean size which is 2 μm to 15 μm to form the similar soft carbon, therefore achieve the effect and purpose for a high-rate rapid charging of lithium ion batteries, an excellent storage performance at high and low temperatures condition and a long charge and discharge cycle life.

### BRIEF DESCRIPTION OF THE DRAWINGS

FIG. 1 is a flow diagram of the manufacture of anode materials with a similar soft carbon of the present invention.

FIG. 2 is a schematic diagram of an isotropic coke and an anisotropic coke.

FIG. 3 is a polarized light microscope photographs of the isotropic coke of the present invention.

FIG. 4 is a schematic diagram comparing the interlayer spacing d002 between the similar soft carbon and a graphite.

FIG. 5 is a structural schematic diagram of a hard carbon, a similar soft carbon, and a graphite.

FIG. 6 is a Scanning Electron Microscope (SEM) photo of the similar soft carbon material of the present invention.

FIG. 7 is a schematic diagram of the high-temperature 45 degrees Celsius cycle life of the similar soft carbon material of the present invention.

FIG. 8 is a schematic diagram of the temperature change of the similar soft carbon material of the present invention.

FIG. 9 is a schematic diagram of the charging rate of the similar soft carbon material of the present invention.

FIG. 10 is a schematic diagram of the discharge rate of the similar soft carbon material of the present invention.

### DETAILED DESCRIPTION OF PREFERRED EMBODIMENTS

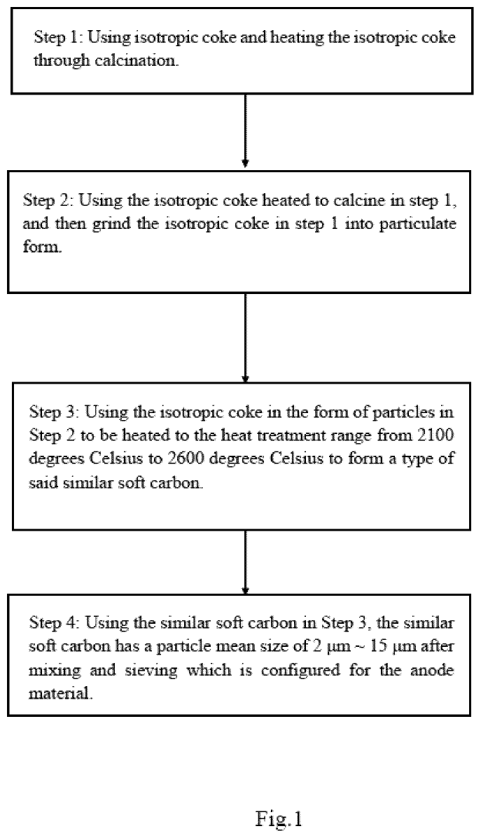

As shown in FIG. 1, the present invention is modification method for a manufacture of anode materials with a similar soft carbon, comprises: Step 1: Using isotropic coke and heating the isotropic coke through calcination; Step 2: Using the isotropic coke heated to calcine in step 1, and then grind the isotropic coke in step 1 into particulate form; Step 3: Using the isotropic coke in the form of particles in Step 2 to be heated to the heat treatment range from 2100 degrees Celsius to 2600 degrees Celsius to form a type of said similar soft carbon; and Step 4: Using the similar soft carbon in Step 3, the similar soft carbon has a particle mean size of 2 μm to 15 μm after mixing and sieving which is configured for the anode material.

As shown in Table 1, the present invention is a manufacture of anode materials with a similar soft carbon, and the specifications used are as follows:

| Item | | Unit | Specification | Measured value |
|---|---|---|---|---|
| Particle | D10 | μm | 2-5 | 3.56 |
| size | D50 | | 6-9 | 7.10 |
| | D90 | | 12-15 | 14.77 |

| | | | |
|---|---|---|---|
| Specific capacity | mAh/g | ≥270 | 281 |
| First Coulombic efficiency | % | ≥90 | 90.6 |

As shown in Table 2, the present invention is a manufacture of anode materials with a similar soft carbon, and the temperature is controlled in the range of 2100 degrees Celsius to 2600 degrees Celsius. The similar soft carbon formed is a specific structure under graphitization temperature control. Wherein the graphitization temperature control range and the corresponding structure thereof are as follows:

TABLE 2

| | Celsius | |
|---|---|---|
| Stage | temperature | Structural state |
| Carbon precursor | 0 | — |
| adjustment stage | 500 | Low molecular weight outgassing |
| Carbonization | 1000 | The main component is carbon |
| stage | 1500 | Carbonization starts |
| | 2000 | Graphitization starts |
| Graphitization | 2500 | Medium temperature graphitization |
| stage | 3000 | High temperature graphitization |

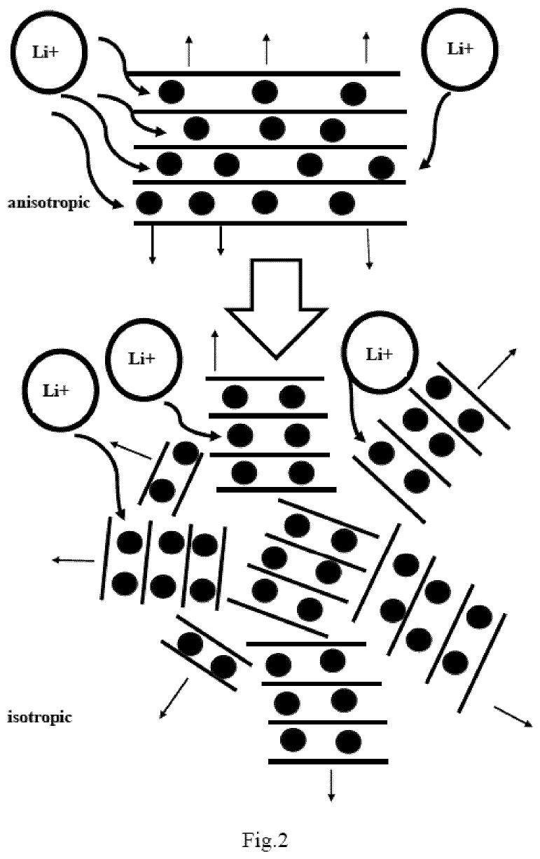

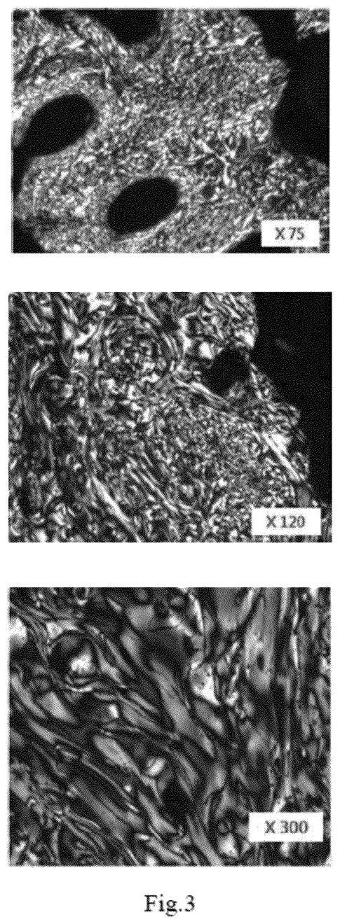

As shown in FIG. 2, the anode material of the present invention, such as the similar soft carbon which is isotropic coke. Wherein an isotropic coke has channels in various directions, which is conducive to the rapid entry and exit of lithium ions. Therefore, the lithium ion battery has a high-rate rapid charge and discharge and excellent storage performance at high and low temperature condition. In addition, the similar soft carbon has a long charge-discharge cycle life and better safety performance. An anisotropic coke and a needle coke are not used as the similar soft carbon of anode materials in the present invention, because the anisotropic coke does not have channels in all directions. Compared with the isotropic coke in the present invention, The anisotropic coke is not suitable to the rapid entry and exit of lithium ions. As shown in FIG. 3, the polarized light microscope photograph of the isotropic coke as the anode material of the present invention is shown.

As shown in FIG. 3, the similar soft carbon such as the anode material of the present invention, the polarized light microscope photos thereof at different magnifications: ×75 magnification, ×120 magnification, and ×300 magnification. Wherein an isotropic coke is used in the ambient heated by calcination which is under a positive pressure ambient of argon (Ar) or nitrogen (N₂) to avoid an isotropic coke with oxygen to synthesize excessively carbon dioxide. A preferred embodiment is to start heating an isotropic coke at room temperature and pour nitrogen (N₂) into the reaction furnace. During the heating period, the pressure of the reaction furnace should be greater than 1.05 atmospheres. When heating continues to 1600 degrees Celsius, stop pouring nitrogen. (N₂) in the reaction furnace, instead pour argon (Ar) to maintain the positive pressure of the reaction furnace, which is greater than 1.05 atmospheres; continue heating to a temperature range from 2100 degrees Celsius to 2600 degrees Celsius and maintain the temperature for 8 hours. After maintaining the temperature for 8 hours, when the temperature drops to 1600 degrees Celsius, stop pouring argon (Ar) into the reaction furnace and replace argon (Ar) with nitrogen (N₂). Maintain the positive pressure of the reaction furnace until the temperature drops to 50 degrees Celsius, then stop injecting nitrogen (N₂).

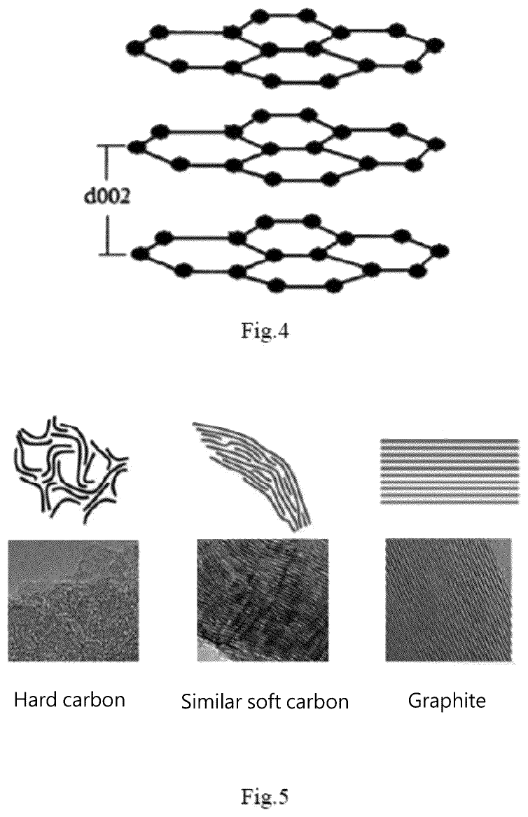

As shown in FIG. 4, a preferred embodiment of the graphitization degree of the similar soft carbon such as the anode material of the present invention is graphitization degree

$$( g ) = \frac{0.344 - d 002}{0.344 - 0.3354} \times 100 \% = 70 \% to 82 \% ,$$

where d002 is the interlayer spacing of the similar soft carbon. In a preferred embodiment of the present invention, the interlayer spacing range of the similar soft carbon is between 0.33798 nm and 0.33695 nm. The interlayer spacing (d002) of the soft carbon is between 0.370 nm and 0.400 nm. The theoretical interlayer spacing (d002) for complete graphitization is 0.3354 nm. For the interlayer spacing (d002) range which are the soft carbon≥the similar soft carbon≥the graphite. Therefore, for materials of the same thickness, the superposition condition of materials and the number of superimposed layers are the soft carbon≤the similar soft carbon≤the graphite. Lithium ions (Li+) move in and out of the anode material quickly, since that the anode material is configured with a large interlayer spacing (d002). Lithium ions (Li+) enter and exit the anode material slowly, since that the anode material is configured with a small interlayer spacing (d002). However, for stacking condition of anode materials, the more stacked layers there are, the more lithium ions (Li+) are stored. The fewer number of stacked layers of anode material, the less lithium ions (Li+) are stored.

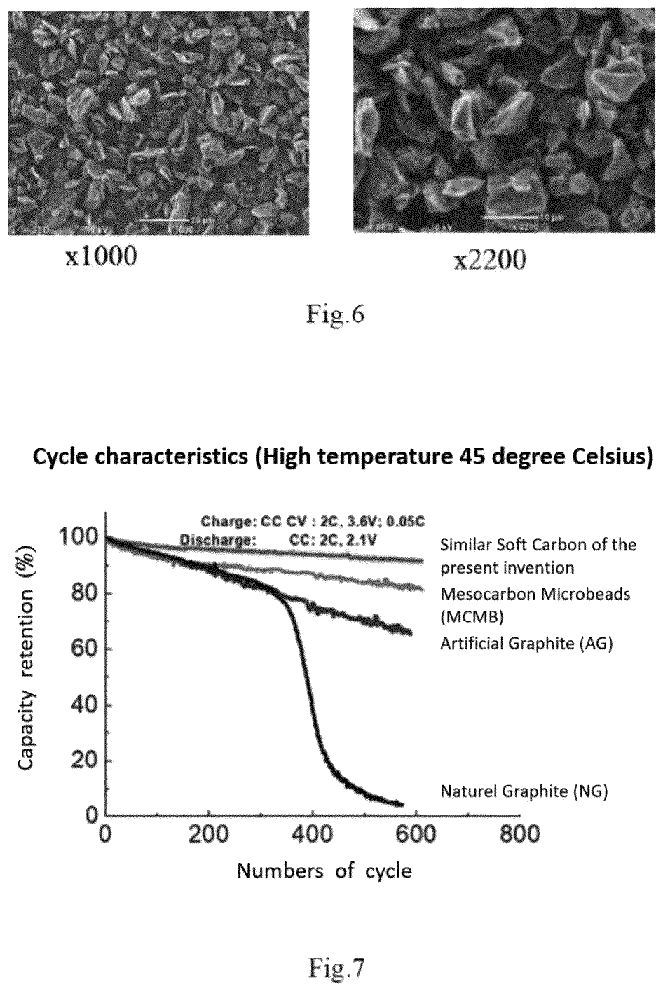

As shown in FIG. 5, the structural diagram of the hard carbon, the similar soft carbon, and the graphite. As shown in FIG. 6, the scanning electron microscope (SEM) photos of the similar soft carbon, such as the anode material of the present invention, are taken at different magnifications: ×1000 magnification and ×2200 magnification.

As shown in FIG. 7, in a high temperature environment of 45 degrees Celsius, the effects of charge and discharge cycle life are compared, comprising: the anode materials of the present invention such as the similar soft carbon, The Mesocarbon Microbeads (MCMB), the Artificial Graphite (AG) and the Natural Graphite (NG). The horizontal axis of FIG. 7 is cycle numbers. The vertical axis of FIG. 7 is capacity retention. When the cycle numbers are 600, the capacity retention of the similar soft carbon, the Mesocarbon Microbeads (MCMB), the Artificial Graphite (AG) and the Natural Graphite (NG) are 92%, 85%, 70% and 5% respectively. Therefore, when cycled in a high temperature environment of 45 degrees Celsius, the capacity retention of the similar soft carbon, such as the anode material of the present invention, is superior to the capacity retention of the Mesocarbon Microbeads (MCMB), the Artificial Graphite (AG) and the Natural Graphite (NG) respectively.

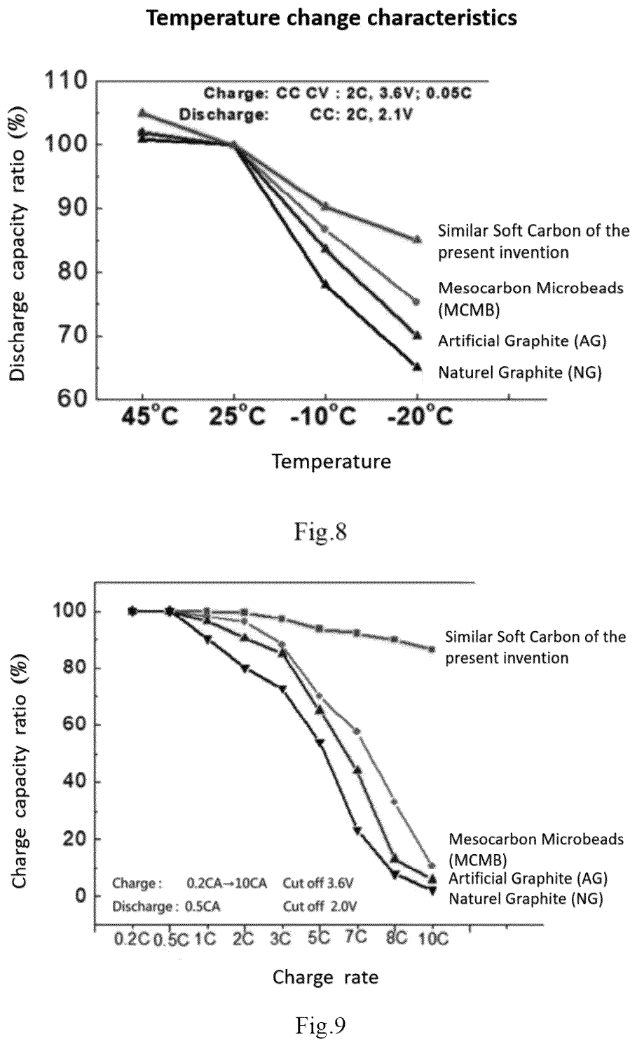

As shown in FIG. 8, a schematic diagram of the discharge capacity ratio and temperature changes. The horizontal axis of FIG. 8 is the environment between 45 degrees Celsius and −20 degrees Celsius. The vertical axis of FIG. 8 is the discharge capacity ratio at 2 C charge rate and 2 C discharge rate relative to 25 degrees Celsius. The effect of the similar soft carbon such as the anode material of the present invention, the discharge capacity ratio at 45 degrees Celsius is 105%. The discharge capacity ratio at −20 degrees Celsius is 86%. Comparing the discharge capacity effect of the discharge capacity ratio of the similar soft carbon is higher than that of the Mesocarbon Microbeads (MCMB), the Artificial Graphite (AG) and the Natural Graphite (NG), that are under high and low temperature condition changes.

As shown in FIG. 9, a schematic diagram of the charge rate of different materials. Compare the effect of the charging capacity ratio with different charging rates under the same 0.5 C discharge rate environment. The horizontal axis of FIG. 9 is different charging rates, wherein “10 C” is 60 minutes/10=6 minutes/single charge. The vertical axis of FIG. 9 is the charging capacity ratio under different charging rates, relative to 0.2 C charging rate. Under the charging state of 0.2 C, the corresponding charging capacity ratio of the similar soft carbon such as the anode material of the present invention is 100%. Under the 10 C charging rate state of the similar soft carbon such as the anode material of the present invention, the charging capacity ratio is 88%. The cycles for charging capacity ratio effect of the charge rate of the similar soft carbon, such as the anode material of the present invention, is higher than the charging capacity ratio effect of the Mesocarbon Microbeads (MCMB), the Artificial Graphite (AG) and the Natural Graphite (NG).

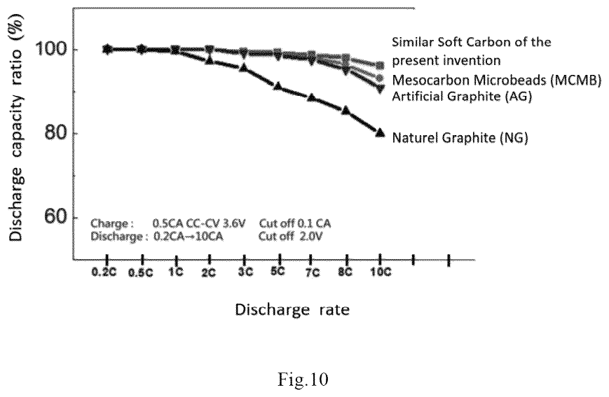

As shown in FIG. 10, a schematic diagram of the discharge rate of different materials. Compare the effect of the discharge capacity ratio under different discharge rates under the same 0.5 C charge rate environment. The horizontal axis of FIG. 10 represents different discharge rates, wherein “10 C” is 60 minutes/10=6 minutes/single discharge. The vertical axis of FIG. 10 is the discharge capacity ratio under different discharge rates, relative to the discharge capacity ratio under 0.2 C discharge capacity. Under the discharge state of 0.2 C, the discharge capacity ratio corresponding to the similar soft carbon such as the anode material of the present invention is 100%. Under the 10 C discharge rate state of the similar soft carbon such as the anode material of the present invention, the discharge capacity ratio is 97%. The cycles for discharge capacity ratio effect of the discharge rate of the similar soft carbon, such as the anode material of the present invention, is higher than the discharge capacity ratio effect of the Mesocarbon Microbeads (MCMB), the Artificial Graphite (AG) and the Natural Graphite (NG).

The foregoing descriptions and explanations are only descriptions of the preferred embodiments of the present invention. Those who has ordinary knowledge of this technology may make other modifications based on the patent scope defined following and the foregoing descriptions. However, these modifications should still be the creative spirit of the present invention and within the scope of rights of the present invention.

What is claimed is:

1. A manufacture of an anode material with similar soft carbon, comprising:
step 1: using isotropic coke and heating the isotropic coke through calcination;
step 2: using the isotropic coke heated to calcine in step 1, and then grinding the isotropic coke in step 1 into particulate form;
step 3: using the isotropic coke in the form of particles in step 2 to be heated to the heat treatment range from 2100 degrees Celsius to 2600 degrees Celsius to form a type of said similar soft carbon; and
step 4: using the similar soft carbon in step 3, wherein the similar soft carbon has a particle mean size of 2 μm to 15 μm after mixing and sieving which is configured for the anode material.

2. The manufacture of the anode material with similar soft carbon as claimed in claim 1, wherein the heat treatment in step 3 raises the temperature and the holding time in the range from 2100 degrees Celsius to 2600 degrees Celsius is 8 hours.

3. The manufacture of the anode material with similar soft carbon as claimed in claim 1, wherein the degree of graphitization (g) of the similar soft carbon,
$$( g ) = \frac{0.344 - d 002}{0.344 - 0.3354} \times 100 \% = 70 \% to 82 \% ,$$
wherein d002 is the interlayer spacing of the similar soft carbon, where the interlayer spacing of the similar soft carbon ranges from 0.33798 nm to 0.33695 nm.

4. The manufacture of the anode material with similar soft carbon as claimed in claim 1, wherein the charging rate of the similar soft carbon is 0.2 C to 10 C, the charging capacity ratio is between 100% and 88% thereof.

5. The manufacture of the anode material with similar soft carbon as claimed in claim 1, wherein a discharge rate of the similar soft carbon is 0.2 C to 10 C, a discharge capacity ratio is between 100% and 97% thereof.

6. The manufacture of the anode material with similar soft carbon as claimed in claim 1, wherein the similar soft carbon has a capacity retention of 99% to 90% after 200 to 600 cycles of charge and discharge in an environment of 45 degrees Celsius.

7. The manufacture of the anode material with similar soft carbon as claimed in claim 1, wherein the similar soft carbon has a capacity retention of 100% to 90% in an environment of 25 degrees Celsius to −10 degrees Celsius, wherein the capacity retention of the similar soft carbon is 90% to 85% in an environment of −10 degrees Celsius to −20 degrees Celsius.

8. The manufacture of the anode material with similar soft carbon as claimed in claim 1, wherein the similar soft carbon is applied to lithium ion batteries and sodium ion batteries.

9. An application of an anode material with similar soft carbon, which is used from claim 1, wherein the application of the similar soft carbon is applied to a start-stop battery, a starting battery, and a high-power hybrid electric vehicle (HEV) battery.
